(19) United States
(12) Patent Application Publication
(10) Pub. No.: US 2007/0070631 A1
(43) Pub. Date: Mar. 29, 2007

(54) [LED LAMP TUBE]

(75) Inventors: Ming-Chung Huang, TAIPEI (TW); Yu-Yang Liu, TAIPEI (TW)

Correspondence Address: LEDTECH ELECTRONICS CORP., P.O. BOX 108-00403, TAIPEI, TW

(73) Assignee: LEDTECH ELECTRONICS CORP., Hsin-Tien City, Taipei Hsien (TW)

(21) Appl. No.: 11/162,892

(22) Filed: Sep. 27, 2005

(51) Int. Cl. F21V 3/00

(52) U.S. Cl. 362/311

(57) ABSTRACT

A LED lamp tube connectable to a conventional lamp holder is disclosed to include a circuit board, multiple arrays of LEDs (light emitting diodes) installed in the circuit board, an outer tubular shell that accommodates the circuit board and the LEDs, and two electric connectors provided at the two ends of the circuit board and extending out of the tubular shell for connecting the circuit board to respective connecting holes at a conventional lamp holder to obtain the necessary working voltage.

### BACKGROUND OF THE INVENTION

1. Field of the Invention

The present invention relates to lamps and more particularly, to a LED lamp tube that can directly be installed in a conventional lamp holder.

2. Description of the Related Art

The invention of lamp changes the living style of human beings. Without lamp, we cannot work at night or in the dark, and the living standard of human beings will stay in the level of the old time.

Commercial lighting fixtures commonly use fluorescent lamps, incandescent lamps, or the so-called power-saving lamps to give off light for illumination. These lighting fixtures have the common drawbacks of high power consumption, quick light attenuation, short service life, fragile characteristic, and being not reclaimable. Further, during the operation of a fluorescent lamp, electric current passes through the electrodes at a high frequency about 120 times per second, causing sparkling of light that is harmful to the eyes. In order to eliminate this problem, a high-frequency electronic ballast may be used. The use of a high-frequency electronic ballast in a fluorescent lamp saves power consumption and stabilizes the electric current, preventing the problem of sparkling of light. However, the high-frequency electronic ballast of a fluorescent lamp is not detachable. When the fluorescent lamp is damaged, the high-frequency electronic ballast cannot be removed from the fluorescent lamp for a repeat use. Further, because conventional fluorescent lamps have a mercury coating coated on the inside wall of the respective lamp tube, the used fluorescent lamps must be properly disposed of to prevent pollution to the environment.

### SUMMARY OF THE INVENTION

The present invention has been accomplished under the circumstances in view. It is the main object of the present invention to provide a LED lamp tube, which is directly connectable to a conventional lamp holder. It is another object of the present invention to provide a LED lamp tube, which has the advantages of quick reaction time, small size, low power consumption, low pollution, high brightness, and long service life. To achieve these and other objects of the present invention, the LED lamp tube comprises a tubular shell, a circuit board mounted in the tubular shell, arrays of LEDs (light emitting diodes) installed in the circuit board inside the tubular shell, and two electric connectors respectively electrically connected to the two distal ends of the circuit board and respectively extending out of the tubular shell for connection to a respective connecting holes of the conventional lamp holder to obtain the necessary working voltage from the lamp holder for the circuit board and the LEDs.

### BRIEF DESCRIPTION OF THE DRAWINGS

FIG. 1 is an exploded view of a LED lamp tube without a tubular shell according to the present invention.

FIG. 1A is an elevational view of an alternate form of the LED lamp tube without a tubular shell and a lamp holder according to the present invention.

FIG. 2 is an exploded view of a LED lamp tube with a tubular shell and a lamp holder according to the present invention.

FIG. 3 is an assembly view of FIG. 2.

FIG. 3A is a perspective view of an alternate form of the LED lamp tube with tubular shell according to the present invention.

### DETAILED DESCRIPTION OF THE PREFERRED EMBODIMENT

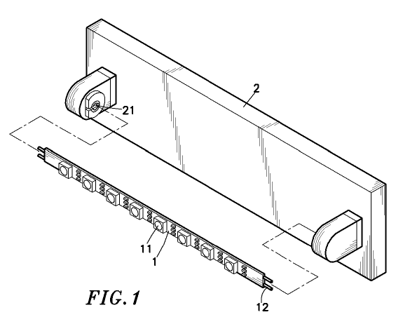

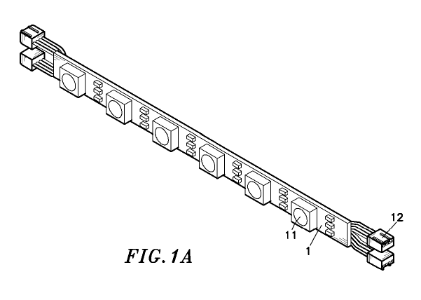

Referring to FIG. 1, a LED lamp tube in accordance with the present invention is shown comprising a narrow elongated, circuit board 1, a plurality of LEDs (light emitting diodes 11 installed in the circuit board 1 and arranged in arrays, and two electric connectors 12 provided at the two distal ends of the circuit board 1 and connectable to a respective connecting holes 21 at a conventional lamp holder 2 to receive power supply through the lamp holder 2. The electric connectors 12 may be variously embodied. According to the embodiment shown in FIG. 1, each electric connector 12 is comprised of two tube pins. According to the embodiment shown in FIG. 1A, each electric connector 12 is comprised of two plugs.

After connection of the electric connectors 12 to the respective connecting holes 21 of the lamp holder 2, the circuit board 1 can obtain the necessary working voltage from the lamp holder 2 to drive the LEDs 11, causing the LEDs 11 to give off light.

Further, the circuit board 1 may be made in any of a variety of other shapes and with the electric connectors 12 to fit any of a variety of other different conventional lamp holders 2 for use as a desk lamp, cabinet lamp, car lamp, etc.

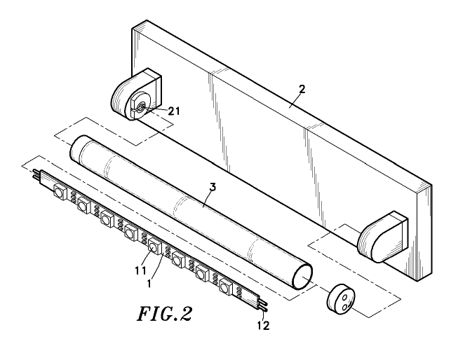

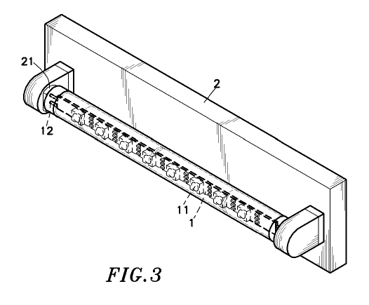

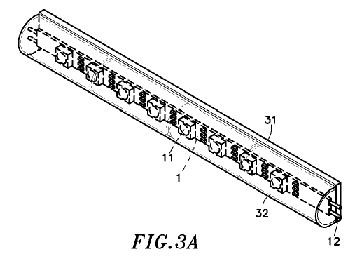

Referring to FIGS. 2 and 3, an outer tubular shell 3 is provided for accommodating the circuit board 1 and the LEDs 11 at the circuit board 1. Preferably, the tubular shell 3 has end caps that close the two distal ends of the tubular shell 3. After installation of the circuit board 1 with the LEDs 11 in the tubular shell 3, the electric connectors 12 extend out of the end caps of the tubular shell 3 for connection to the connecting holes 21 of the lamp holder 2. The tubular shell 3 can be transparent, translucent, partially transparent or any of a variety of other materials in any of a variety of colors. Further, the tubular shell 3 may be made having a flat mounting base 31 and a light permeable shade 32 covered on the flat mounting base 31 over the circuit board 1 and the LEDs 11 at the circuit board 1.

As indicated above, the present invention provides a LED lamp tube, which is comprised of a tubular shell 3 that admits light, a circuit board 1 mounted inside the tubular shell 3, and two electric connectors 12 electrically connected to the circuit board 1 and respectively extending out of the two distal ends of the tubular shell 3 for connection to the respective connecting holes 21 of a conventional lamp holder 2. Because the invention uses LEDs to give off light, the LED lamp tube of the invention has the advantages of quick reaction time, small size, low power consumption, low pollution, high brightness, and long service life.

Although particular embodiments of the invention have been described in detail for purposes of illustration, various modifications and enhancements may be made without departing from the spirit and scope of the invention.

What is claimed is:

1. A LED lamp tube comprising a circuit board made subject to the size of a conventional lamp holder, multiple arrays of light emitting diodes installed in said circuit board, and two electric connectors for connecting said circuit board to respective connecting holes at said conventional lamp holder for enabling said light emitting diodes and said circuit board to obtain the necessary working voltage from said connected lamp holder.

2. The LED lamp tube as claimed in claim 1, wherein said two electric connectors of said LED lamp tube are respectively electrically connected to two opposite ends of said circuit board.

3. The LED lamp tube as claimed in claim 1, wherein said electric connectors are tube pin type electric connectors.

4. The LED lamp tube as claimed in claim 1, wherein said electric connectors of said LED lamp tube each are comprised of at least one plug member.

5. The LED lamp tube as claimed in claim 1, further comprising a tubular shell that accommodates said circuit board and said light emitting diodes.

6. The LED lamp tube as claimed in claim 5, wherein said tubular shell is transparent, translucent, partially transparent or any of a variety of other materials in any of a variety of colors.

7. The LED lamp tube as claimed in claim 5, wherein said tubular shell comprises a flat mounting base that supports said circuit board and said light emitting diodes on said circuit board, and a light permeable shade covered on said flat mounting base over said circuit board and said light emitting diodes, and said flat mounting base is formed integral with said light permeable shade.
